(19) United States
(12) Patent Application Publication
(10) Pub. No.: US 2009/0119116 A1
(43) Pub. Date: May 7, 2009

(54) METHOD AND SYSTEM FOR CREDIT REPORT REMINDER SERVICE

(75) Inventor: Garnet Hugh Steen, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: RelyData LLC, Chicago, IL (US)

(21) Appl. No.: 11/935,150

(22) Filed: Nov. 5, 2007

(51) Int. Cl. G06Q 99/00

(52) U.S. Cl. 705/1

(57) ABSTRACT

Methods and systems are described for a credit report reminding service. A reminder service receives credit report reminder requests and credit report retrieval history from one or more consumers, such that one or more servers, software applications and databases are used to store and generate one or more consumer credit report retrieval schedules. The reminder service transmits credit report reminders to consumers based on the credit report retrieval schedules, and receives acknowledgements from the consumers when they have retrieved free credit reports.

### BACKGROUND OF THE INVENTION

With the increasing amount of identity theft and of fraudulent credit-related activities, consumers are becoming more vigilant in monitoring their credit history and protecting their personal identifiable information (PII). Three credit reporting bureaus, Experian, Equifax and TransUnion, have become the de facto storehouses of consumer credit information, which are used by potential lenders, creditors and others to determine creditworthiness of individual consumers and verify PII. Until recently, it was difficult for consumers to view the actual information stored in those bureaus' repositories, however. With the passage of recent legislation, each of the three credit reporting bureaus must now allow a consumer to obtain a free credit report at least once a year.

### BRIEF SUMMARY OF THE INVENTION

A method and system for a credit report reminding service is provided. A reminder service receives credit report reminder requests and credit report retrieval history from one or more consumers, such that one or more servers, software applications and databases are used to store and generate one or more consumer credit report retrieval schedules. The reminder service transmits credit report reminders based on the credit report retrieval schedules and receive acknowledgements from the consumers when they have retrieved the free credit report.

In one aspect, a method is provided for reminding a consumer to obtain a plurality of free credit reports from a plurality of credit reporting bureaus, comprising receiving a request from the consumer, through a user interface, to provide reminders to obtain free credit reports from the plurality of credit reporting bureaus, querying the consumer, through the user interface, for identification information and past credit reporting information, storing the identification information and past credit reporting information into one or more databases, determining, using the past credit reporting information, a first date on which a reminder is to be sent to the consumer with respect to a first credit reporting bureau in the plurality of credit reporting bureaus, and transmitting a reminder message to the consumer on approximately the first date, across a communication network, to obtain a free credit report from the first credit reporting bureau.

In another aspect, a system is provided for reminding a consumer to obtain a plurality of free credit reports from a plurality of credit reporting bureaus, comprising a user interface that receives information from and reports information to the consumer, a communication network that transmits queries, notifications, reminder messages, identification information, and past credit reporting information between a user interface and a server, a server that transmits information to and receives information from a user interface, across a communication network and stores information in and accesses information from one or more databases, one or more databases that store consumer identification information and past credit reporting information; and a software application that processes database information to provide a consumer a reminder to obtain a plurality of free credit reports from a plurality of credit reporting bureaus.

In still another aspect, a method is provided for reminding a consumer to obtain a plurality of free credit reports from a plurality of credit reporting bureaus, comprising requesting a credit reporting reminder service by a consumer, through a user interface, to provide reminders to obtain free credit reports from the plurality of credit reporting bureaus, providing the credit reporting reminder service, through a user interface identification information and past credit reporting information, receiving a reminder message from the credit reporting reminder service on approximately a first date, across a communication network, to obtain a free credit report from a first credit reporting bureau, and transmitting a notification across a communication network that notifies the credit report reminder service that the consumer has obtained free credit report from the first credit reporting bureau.

### BRIEF DESCRIPTION OF THE SEVERAL VIEWS OF THE DRAWING(S)

FIG. 1 is a general architectural overview of an embodiment of the invention that shows a system for a credit reminder service;

FIG. 2 is a flow diagram of an embodiment of the invention, illustrating a method for a credit report reminder service;

FIG. 3 is an exemplary user interface in accordance with an embodiment of the invention;

FIG. 4 is an exemplary user interface in accordance with an embodiment of the invention;

FIG. 5 is an exemplary user interface in accordance with an embodiment of the invention;

FIG. 6 is an exemplary user interface in accordance with an embodiment of the invention;

FIG. 7 is an exemplary user interface in accordance with an embodiment of the invention;

FIG. 8 is an exemplary user interface in accordance with an embodiment of the invention;

FIG. 9 is an exemplary credit report reminder in accordance with an embodiment of the invention; and

FIG. 10 is an exemplary credit report reminder in accordance with an embodiment of the invention.

### DETAILED DESCRIPTION OF THE INVENTION

The increasing number of fraudulent activities warrants consumers to vigilantly monitor and protect their credit history information and PII. Each of the three major credit reporting bureaus allows a consumer to obtain a free credit report at least once a year from them. Further, certain states allow their residents to access free credit reports more frequently and consumers may obtain a free credit report whenever they are rejected for credit based on information in the credit report. Obtaining frequent credit reports allows consumers to monitor and protect their credit history and PII, thus providing them with a firm financial foundation and prevent the misuse of their identities.

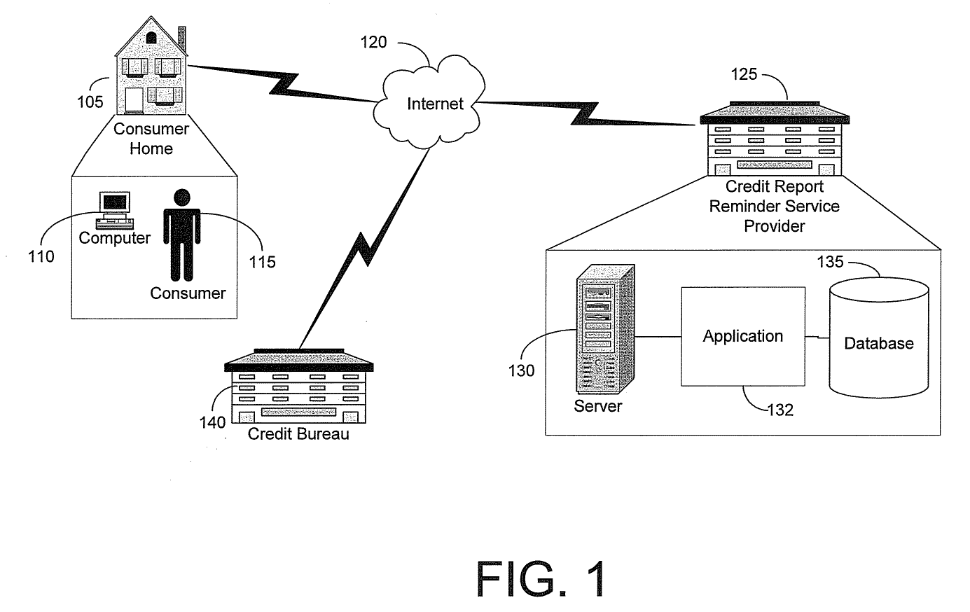

Embodiments of the present invention provide a credit report reminder service to allow consumers to frequently monitor their credit history. FIG. 1 is a general architectural overview of an embodiment of the invention that shows a system for a credit reminder service. For example, a consumer 115 may sign up for a credit report reminder service across the Internet 120 from a credit report reminder service provider (CRSP) 125 website. The CRSP 125 provides the consumer with a website and credit report reminder service using a server 130, software application 132, and a database 135. The software application 132 allows a CRSP 125 to provide a credit report reminder service by storing and accessing consumer information from the database 135. The server 130 implements the software application 132 to calculate dates when reminders are to be sent to the consumers, and to send reminders on or near those dates to the consumers to remind them to obtain their free credit reports. FIG. 1 is an exemplary embodiment of the invention. Alternative embodiments may implement one or more servers, software applications, and databases to implement the invention. Once the CRSP provides a consumer with a credit report reminder, the consumer may retrieve the free credit report across the Internet 120 from a credit bureau website 140. Alternate servers may indicate that the software application is hosted by a licensee, such as a financial institution, on behalf of its customers.

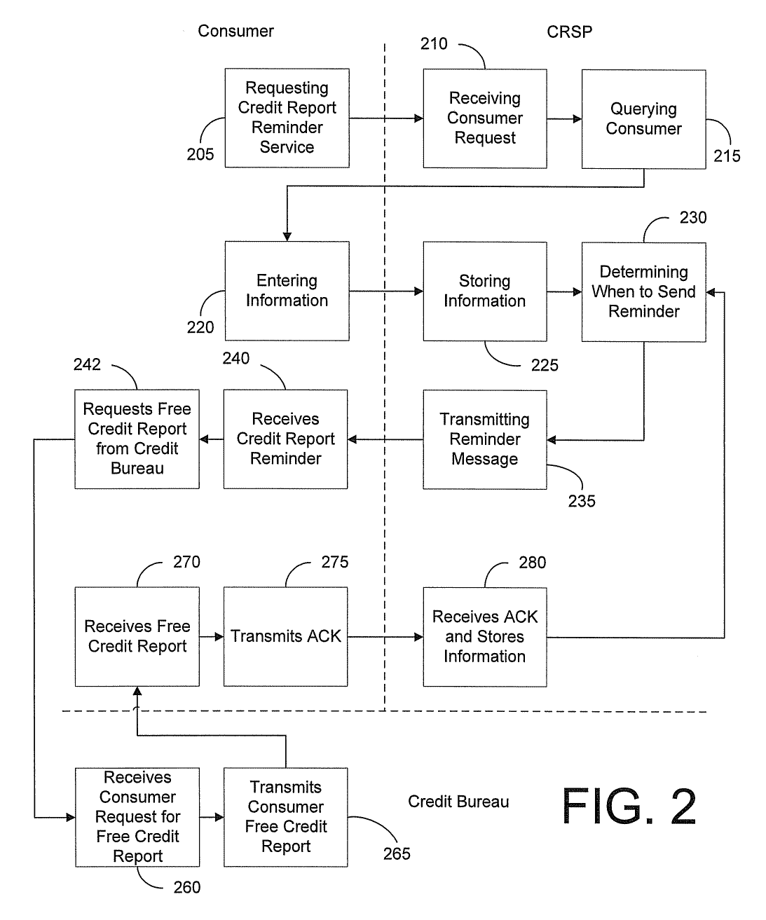

FIG. 2 is a flow diagram of an embodiment of the invention, illustrating a method for a credit report reminder service. At a step 205, a consumer requests a credit report reminder service from a CRSP and provides PII such as state of residence that may affect the credit report retrieval schedule. At a next step 210, a CRSP receives the consumer request. At a next step 215, the CRSP queries the consumer for information regarding his credit report retrieval history. The consumer enters this information at step 220. At step 225, the CRSP stores the entered information as a consumer credit report retrieval history in one or more databases. The CRSP uses a software application at step 230 to determine when to send the consumer a reminder to retrieve a free credit report. At the determined time, the CRSP transmits a reminder message to the consumer at step 236. At step 240, the consumer receives the credit report reminder from the CRSP, and the consumer requests a free credit report from a credit bureau at step 242. The credit bureau receives the consumer request for a free credit report at step 260 and, at step 265, transmits a free credit report to the consumer. At step 270, the consumer receives the free credit report from the credit bureau. The consumer then transmits an acknowledgement to the CRSP at step 275 that it received the free credit report, preferably including details such as the date and name of the credit bureau from where the report was obtained. At step 280, the CRSP receives the acknowledgement information and stores it into one or more databases and updates the retrieval schedule to reflect this addition to the retrieval history. The CRSP then begins the process again from step 230 by determining a new date on which a reminder is to be sent to the consumer.

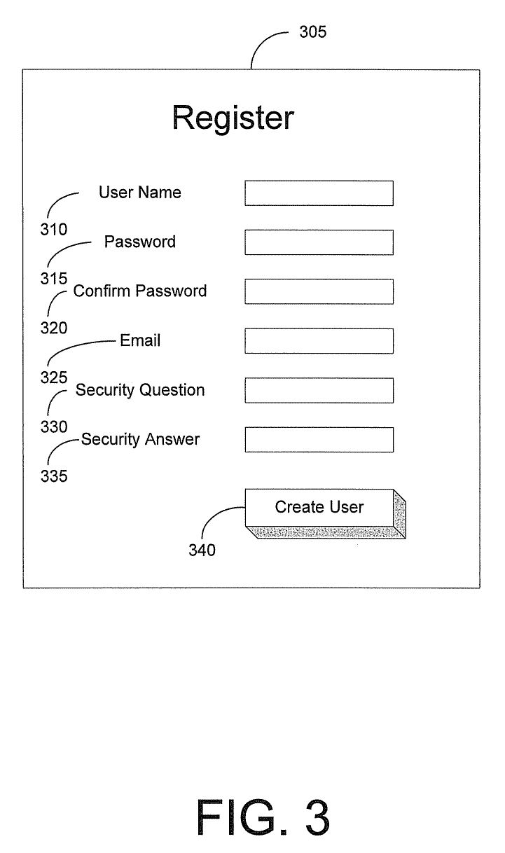

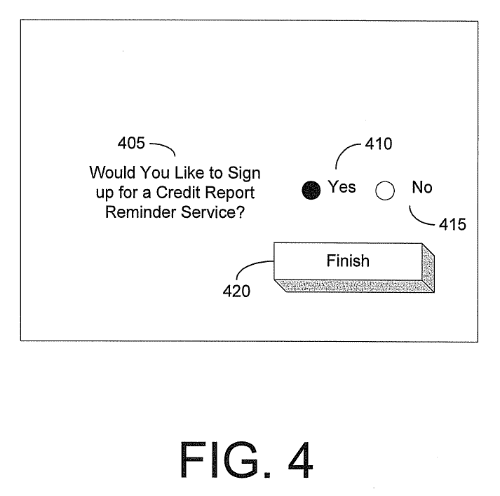

FIG. 3 is an exemplary user interface in accordance with an embodiment of the invention. A consumer may use a web user interface 305 provided by a CRSP on its website to register for a credit report reminder service. For example, a consumer may provide a user name 310, password 315, confirmation of password 320, email address 325, security question 330, and security answer 335 to register for the credit report reminder service. Clicking the “Create User” push button 340 completes the registration process. FIG. 4 is another exemplary user interface in accordance with an embodiment of the invention. FIG. 4 shows a consumer may explicitly register for a credit report reminder service (405, 410, 415, and 420).

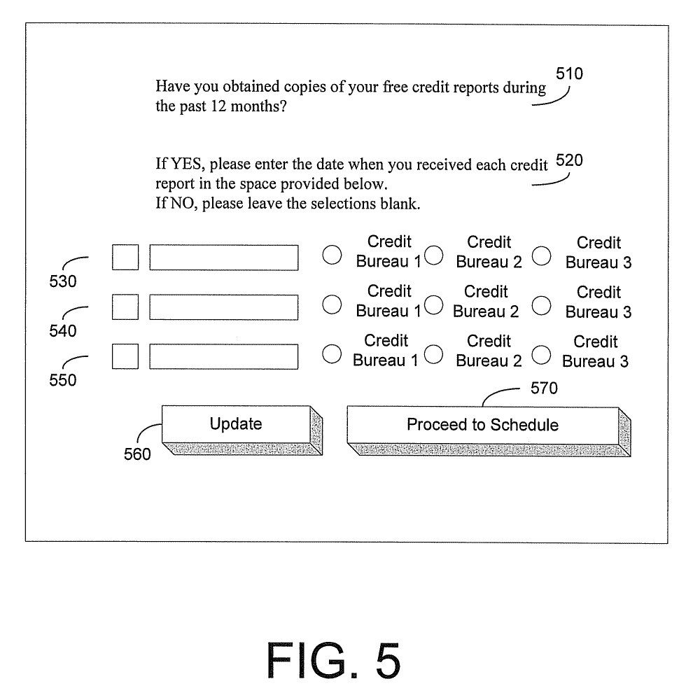

FIG. 5 is another exemplary user interface in accordance with an embodiment of the invention. FIG. 5 shows the CRSP querying the consumer for its credit report retrieval history (510, 520). A consumer may provide the date and the credit bureau it received a credit report in the past twelve months (530, 540, and 550). Clicking the “Update” push button 560 allows the CRSP to update the consumer information in its one or more databases. Clicking the “Proceed to Schedule” push button generates a credit report retrieval schedule for the next twelve months for the consumer.

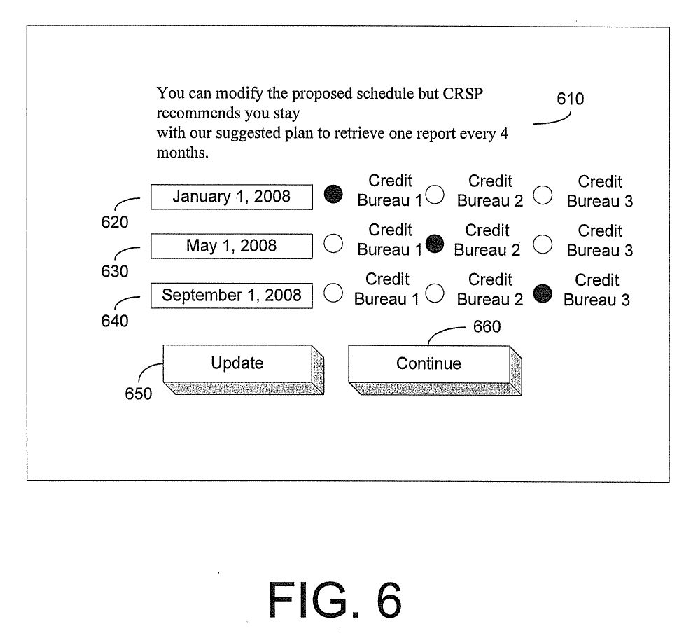

FIG. 6 is another exemplary user interface in accordance with an embodiment of the invention. A CRSP provides a schedule for a consumer to retrieve a free credit report at regular intervals over the next twelve months (620, 630, 640). A CRSP may allow a consumer to modify the schedule (610, 650). If a consumer does modify the schedule, clicking the “Update” push button 650 updates the CRSP database with the information. Clicking the “Continue” push button 660 allows the consumer to proceed to the next web page on the CRSP website.

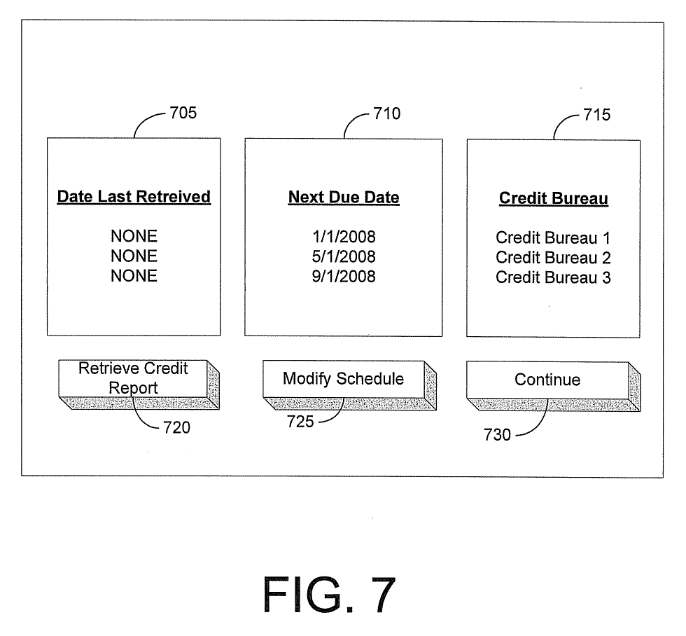

FIG. 7 is another exemplary user interface in accordance with an embodiment of the invention. FIG. 7 provides a chart that reflects a consumer's credit report retrieval history 705 and upcoming credit report retrieval schedule 710 for each credit bureau 715. Clicking the “Retrieve Credit Report” push button 720 allows a consumer to retrieve a free credit report from a credit bureau website. Further, clicking the “Modify Schedule” push button 725 allows a consumer to adjust the upcoming credit report retrieval schedule. In addition, clicking the “Continue” push button 730, allows the consumer to proceed to the next web page on the CRSP website.

Although FIG. 7 shows that a consumer may only retrieve a free credit report from one of three credit bureaus in a year, embodiments of the present invention are not limited to this aspect. For example, embodiments of the present invention may remind a consumer to retrieve a free credit report from more than three credit bureaus in a year. In such an embodiment, a CRSP may send a consumer a credit report reminder more frequently than the schedule shown in FIG. 7. In addition, some states allow a consumer to obtain a free credit report more than once a year. A CRSP, by, for example, querying a consumer's resident zip code, may determine to provide more frequent reminders to the consumer based on his state residence. Similarly, certain state or federal laws or regulations may entitle the consumer to additional free credit reports. In an embodiment of the invention, the consumer is queried with respect to relevant laws and regulations. For example, under existing laws the consumer may be entitled to an additional report within 30 days of applying for credit. The CRSP queries the consumer on this issue (e.g., “Have you applied for credit in the last 30 days?”) and modifies the reminder schedule accordingly if the answer is “Yes” by, for example, sending a reminder to obtain credit reports immediately to take advantage of the 30 day opportunity.

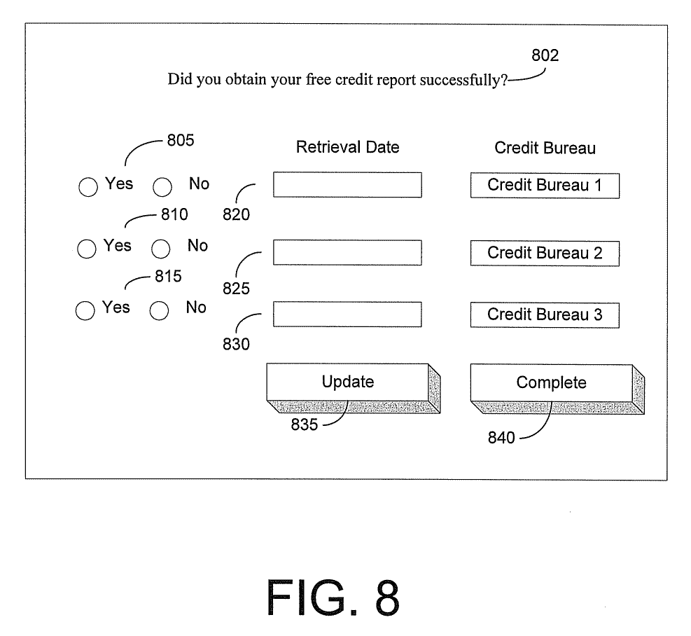

FIG. 8 is another exemplary user interface in accordance with an embodiment of the invention. FIG. 8 queries a consumer whether it successfully obtained a free credit report from each credit bureau 802. A consumer answers the query (805, 810, and 815) and enters a retrieval date for a free credit report from each credit bureau (820, 825, and 830). Clicking the “Update” push button 835 updates the information in the CRSP databases. Clicking the “Complete” push button 840 completes the credit report reminder scheduling service.

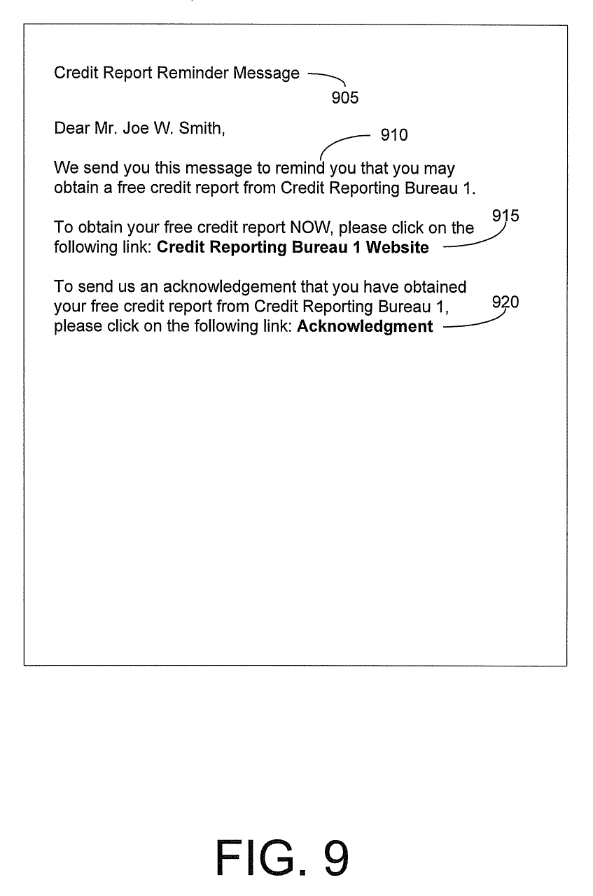

FIG. 9 is an exemplary credit report reminder in accordance with an embodiment of the invention. The credit report reminder message 905 may be in the form of any data message that includes, but is not limited to, an e-mail, text, image, voice, instant messaging, and web page. The message contains a reminder to the consumer to obtain a free credit report from a particular credit bureau 910. The credit report reminder message 905 may allow a consumer to link to a credit bureau website to immediately obtain a free credit report 915. In addition, the credit report reminder message 905 may provide a consumer a link to the CRSP to acknowledge that it has obtained its free credit report from a particular credit bureau 920. Alternatively, or in addition, an embodiment of the invention includes an acknowledgement sent from the particular credit bureau 910 to the CRSP.

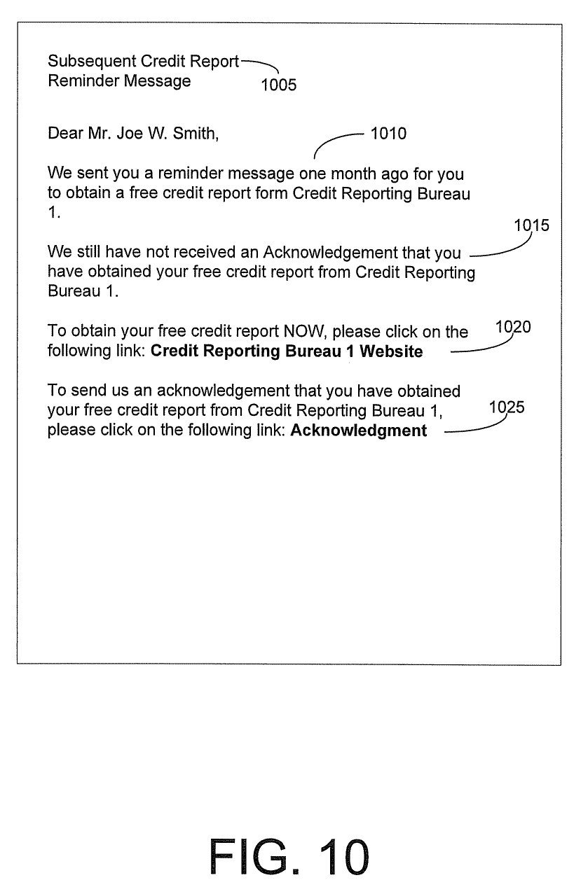

FIG. 10 is an exemplary credit report reminder in accordance with an embodiment of the invention. A subsequent credit report reminder message 1005 may be in the form of any data message that includes, but is not limited to, an e-mail, text, image, voice, instant messaging, and web page. The message 1005, states when the previous reminder message was sent to the consumer 1010 and that the CRSP has not received any acknowledgement information that the consumer obtained its free credit report form that particular credit bureau 1015. Similar to FIG. 9, the message 1005 provides a consumer a link to a credit bureau website to immediately obtain a free credit report 1020 and a link to acknowledge the retrieval to the CRSP 1025.

When a consumer provides an acknowledgment to the CRSP with the date he last retrieved a free credit report from a particular credit bureau, the CRSP stores this information and recalibrates the consumer's credit report retrieval schedule. Typically, the recalibration is such that new schedule includes reminder to the consumer twelve months from the last retrieval date. For example, a consumer's credit report retrieval schedule is as follows: obtain free credit report from Credit Bureau 1 on Jan. 1, 2008; obtain free credit report from Credit Bureau 2 on May 1, 2008; and obtain free credit report from Credit Bureau 3 on Sep. 1, 2008. The CRSP sends a credit report reminder message on Jan. 1, 2008 to the consumer to retrieve a free credit report from Credit Bureau 1. However, the consumer sends a CRSP an acknowledgement that it did not retrieve the free credit report from Credit Bureau 1 until Feb. 1, 2008. The CRSP then updates the consumer credit report retrieval schedule as follows: obtain free credit report from Credit Bureau 2 on Jun. 1, 2008; and obtain free credit report from Credit Bureau 3 on Oct. 1, 2008; and obtain free credit report from Credit Bureau 1 on Feb. 1, 2009. The frequency of reminders is preferably proportional to the number of credit bureaus to be used. In this way, the maximum amount of time a consumer goes without obtaining a free credit report is minimized.

As another example, if the consumer provides information that he has not recently retrieved a credit report, and that he recently applied for credit, and that he lives in a particular state that allows for more frequent credit report retrieval (e.g., twice per year), then the CRSP preferably notifies the consumer to obtain credit reports immediately from each of the three major credit bureaus, and schedules subsequent reminders for every two (2) months. In embodiments of the invention, the CRSP modifies its scheduling algorithm in accordance with changes in state and federal law, such that, for example, if one state's law changes to allow for greater or fewer free annual credit reports, the reminders are sent out more frequently or less frequently, accordingly.

Embodiments of the invention may include provision of CRSP services by or for a financial institution at which the consumer transacts business, or other sponsoring organization. In such embodiments, the financial institution sends the consumer periodic credit report reminder messages in accordance with the embodiments of the invention. For example, a credit union may offer a credit report reminder service with its other financial services to its consumers. Alternatively, a third party CRSP manages the credit report reminder services on behalf of the financial institution, such that the reminder notices are branded with the financial institution's identifying mark. In such embodiments, the financial institution or sponsoring organization may include targeted promotional offers with their reminder messages. Additionally, targeted promotional offers may be based in part on information provided by the consumer, including zip code or other personal characteristics such as age. For example, in an embodiment of the invention the CRSP requests information from the consumer regarding recent loan applications (e.g., “Have you recently applied for a mortgage? Car loan? Home Equity Loan? Etc.”). If, for example, the consumer responded that he had recently applied for a car loan, then the targeted offer from the financial institution can be for a low-rate car loan.

In another embodiment, the CRSP asks follow-up questions of the consumer when the consumer acknowledges receipt of a free credit report. These follow-up questions can be used for diagnostic purposes, based on information the consumer obtained from the report.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for reminding a consumer to obtain a plurality of free credit reports from a plurality of credit reporting bureaus, comprising:
receiving a request from the consumer, through a user interface, to provide reminders to obtain free credit reports from the plurality of credit reporting bureaus;
querying the consumer, through the user interface, for identification information and past credit reporting information;
storing the identification information and past credit reporting information into one or more databases;
determining, using the past credit reporting information, a first date on which a reminder is to be sent to the consumer with respect to a first credit reporting bureau in the plurality of credit reporting bureaus; and
transmitting a reminder message to the consumer on approximately the first date, across a communication network, to obtain a free credit report from the first credit reporting bureau.

2. The method of claim 1 further comprising:
receiving a notification across a communication network that the consumer has obtained a free credit report from the first credit reporting bureau;
determining, using the received notification, a new date on which a reminder is to be sent to the consumer with respect to a first credit reporting bureau in the plurality of credit reporting bureaus; and
transmitting a reminder message to the consumer on approximately the determined new date, across a communication network, to obtain a free credit report from the first credit reporting bureau.

3. The method of claim 1 farther comprising:
determining, using the past credit reporting information, a second date on which a reminder is to be sent to the consumer with respect to a second credit reporting bureau in the plurality of credit reporting bureaus; and
transmitting a reminder message to the consumer on approximately the second date, across a communication network, to obtain a free credit report from the second credit reporting bureau.

4. The method of claim 3 wherein the first date and second date are staggered with respect to the number of credit reporting bureaus in the plurality.

5. A method according to claim 1, further comprising periodically retransmitting a reminder message to the consumer a predetermined period after a first date, across a communication network, to obtain a free credit report from the first credit reporting bureau, if no notification is received wherein the notification states that the consumer has obtained a free credit report from the first credit reporting bureau.

6. A method according to claim 1, further comprising providing a link in the reminder message, wherein clicking the link allows a consumer to obtain a free credit report from the first credit reporting bureau.

7. A method according to claim 1, wherein the reminder message may be selected from a group consisting of an e-mail, a text message, an instant message, an image message, voice mail, and web page.

8. A method according to claim 1, wherein the communication network be selected from a group consisting of a wireless network, a computer network, and a voice communication network.

9. A system for reminding a consumer to obtain a plurality of free credit reports from a plurality of credit reporting bureaus, comprising:
a user interface that receives information from and reports information to the consumer;
a communication network that transmits queries, notifications, reminder messages, identification information, and past credit reporting information between a user interface and a server;
a server that transmits information to and receives information from a user interface, across a communication network and stores information in and accesses information from one or more databases;
one or more databases that store consumer identification information and past credit reporting information; and
a software application that processes database information to provide a consumer a reminder to obtain a plurality of free credit reports from a plurality of credit reporting bureaus.

10. A system according to claim 9, wherein the server comprises a processor wherein the processor implements the software application; and memory wherein the memory stores the software application.

11. A system according to claim 9, wherein the software application periodically analyzes the database consumer identification information and past credit reporting information to determine whether to transmit to a consumer a reminder message to obtain a plurality of free credit reports from a plurality of credit reporting bureaus, wherein the software application analysis comprises of:
analyzing consumer past credit reporting information;
determining, using the past credit reporting information, a first date on which a reminder is to be sent to the consumer with respect to a first credit reporting bureau in the plurality of credit reporting bureaus;
transmitting a reminder message to the consumer on approximately the first date, across a communication network, to obtain a free credit report from the first credit reporting bureaus.

12. A system according to claim 9, wherein the software application analysis further comprises:
determining, using the past credit reporting information, a second date on which a reminder is to be sent to the consumer with respect to a second credit reporting bureau in the plurality of credit reporting bureaus;
transmitting a reminder message to the consumer on approximately the second date, across a communication network, to obtain a free credit report from the second credit reporting bureau;
wherein the first date and second date are staggered with respect to the number of credit reporting bureaus in the plurality.

13. A system according to claim 9, wherein the software application analysis further comprises of periodically retransmitting a reminder message the consumer a predetermined period after a first date, across a communication network, to obtain a free credit report from the first credit reporting bureau, if no notification is received wherein the notification states that the consumer has obtained a free credit report from the first credit reporting bureau.

14. A system according to claim 9, further comprising a link in the reminder message, wherein clicking the link allows a consumer to obtain a free credit report from the first credit reporting bureau.

15. A method for reminding a consumer to obtain a plurality of free credit reports from a plurality of credit reporting bureaus, comprising:
requesting a credit reporting reminder service by a consumer, through a user interface, to provide reminders to obtain free credit reports from the plurality of credit reporting bureaus;
providing the credit reporting reminder service, through a user interface identification information and past credit reporting information;
receiving a reminder message from the credit reporting reminder service on approximately a first date, across a communication network, to obtain a free credit report from a first credit reporting bureau; and
transmitting a notification across a communication network that notifies the credit report reminder service that the consumer has obtained free credit report from the first credit reporting bureau.

16. The method according to claim 15, further comprising receiving a reminder message on approximately a second date, across a communication network, to obtain a free credit report from a second credit reporting bureau wherein the first date and second date are staggered with respect to the number of credit reporting bureaus in the plurality.

17. A method according to claim 15, further comprising of periodically receiving a reminder message a predetermined period after a first date, across a communication network, to obtain a free credit report from the first credit reporting bureau, if no notification is received by the credit report reminder service from the consumer wherein the notification states that the consumer has obtained a free credit report from the first credit reporting bureau.

18. A method according to claim 15, further comprising clicking a link in the reminder message, to obtain a free credit report from the first credit reporting bureau.

19. A method according to claim 15, wherein the reminder message may be selected from a group consisting of an e-mail, a text message, an instant message, an image message, voice mail, and pop-up web page.

20. A method according to claim 15, wherein the communication network be selected from a group consisting of a wireless network, a computer network, and a voice communication network.
